(19) United States
(12) Patent Application Publication
(10) Pub. No.: US 2009/0202972 A1
(43) Pub. Date: Aug. 13, 2009

(54) Bi-Directional Communication of Simulation Information

(75) Inventors: Louai Adhami, Gaithersburg, MD (US); Robert Falk, Takoma Park, MD (US); Christopher J. Ullrich, Ventura, CA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Immersion Corporation, San Jose, CA (US)

(21) Appl. No.: 12/029,620

(22) Filed: Feb. 12, 2008

(51) Int. Cl. G09B 7/00

(52) U.S. Cl. 434/362

(57) ABSTRACT

Systems, methods, and associated software for providing a virtual reality experience for a user, particularly a virtual training experience, are described herein. A server associated with a virtual training system according to one embodiment, among others, comprises memory and a network interface. The memory is configured to store virtual training software and a simulation variations database. The virtual training software comprises training simulation logic adapted to provide a virtual training experience. The simulation variations database comprises data associated with preset variations to the virtual training experience. The network interface is configured to communicate with a remote client device within a network and is further configured to receive a first set of information from the client device associated with the virtual training software. Also, the network interface is further configured to transmit a second set of information to the client device associated with the virtual training software.

### TECHNICAL FIELD

The present disclosure generally relates to virtual reality and more particularly relates to communicating information associated with training simulation software.

### BACKGROUND

Training is used in many fields to enable a person to learn certain crafts, skills, and procedures. By honing these skills, a person can increase his or her proficiency in a particular occupation or trade. For instance, in the medical field, medical students and other medical professionals can receive training for performing different types of surgical procedures. In recent years, systems have been developed that allow medical professionals to practice surgical procedures in a virtual environment. As a result, one advantage of enabling medical professionals to practice surgical procedures on a virtual patient is that an actual human patient is not needed.

Medical simulators are used to emulate what an actual surgery might look like in reality. Furthermore, variations are built into the simulators to allow a medical professional to practice various surgical procedures on various virtual patients. Additional simulation procedures and virtual patients can be incorporated in the medical simulators at a later time to allow a greater range of variability, which can more realistically encompass the experiences that an actual surgeon might face. Although existing medical simulation developers are currently able to distribute additional simulation content, further advancements in the field of medical simulators can still be made at present to improve the virtual training experience for medical professionals.

### SUMMARY

The present disclosure describes systems, methods, and associated software applications for providing a virtual training experience to a user. In one embodiment of a server of a virtual training system, the server comprises memory configured to store virtual training software and a simulation variations database. The virtual training software comprises training simulation logic adapted to provide a virtual training experience. The simulation variations database comprises data associated with preset variations to the virtual training experience. The system also comprises a network interface configured to communicate with a remote client device within a network. The network interface is further configured to receive a first set of information from the client device associated with the virtual training software. Also, the network interface is further configured to transmit a second set of information to the client device associated with the virtual training software.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The following figures illustrate the general principles of the present disclosure. Reference characters designating corresponding components are repeated as necessary throughout the figures for the sake of consistency and clarity.

FIG. 1 is a block diagram of a virtual training system according to one embodiment.

FIG. 2 is a block diagram of the server shown in FIG. 1 according to one embodiment.

FIG. 3 is a block diagram of the memory shown in FIG. 2 according to one embodiment.

FIG. 4 is a block diagram of the virtual training software shown in FIG. 3 according to one embodiment.

FIG. 5 is a block diagram of one of the client devices shown in FIG. 1 according to one embodiment.

FIG. 6 is a graph illustrating information exchange between a server and client device according to one embodiment.

### DETAILED DESCRIPTION

Virtual training for surgical procedures has provided a means for visually displaying images of what a surgery might actually look like in reality. In conventional systems, simulation software can be sent to users on a physical medium or can be downloaded to users via the Internet. Typically, the simulation software is limited to a fixed set of training scenarios for a certain number of surgical procedures. If desired, additional training scenarios and procedures can be provided to the users by a similar delivery method. Generally, a “training scenario” refers to the anatomy and/or physiology of a virtual patient and the pathological effects of a medical condition on the virtual patient.

The present disclosure describes systems and methods for bi-directionally communicating information between a central server and one or more client devices. In particular the information exchange involves data and instruction related to virtual training. Similar to conventional systems, the central server can transmit virtual training information downstream to one or more client devices that are configured to run virtual training software. In addition to the conventional systems, the client devices in accordance with the present disclosure can provide feedback upstream to the central server. The upstream information can serve the purpose of sharing variations of surgical scenarios or novel approaches to certain procedures based on the expertise or non-traditional experiences of a group of surgeons.

The client device can also track a user's performance using a scoring system and then report the scores to the central server. In some embodiments, the client device may further communicate specific information pertaining to the anatomy or physiology of a real life patient. In response to receiving such feedback from the client device, the server can enable the creation of new simulation scenarios for distribution to the contributing client or to a group of clients. The bi-directional exchange of virtual training information allows sharing of useful information among of group of clients having similar training needs. A client can share certain variations from real world experience to allow others to train within a broader range of various possibilities. A group of clients can utilize this system to share new information or new approaches to certain procedures to create a more extensive training product.

In the medical field, variations of human anatomy and physiology can be shared to provide a fuller scope of surgical training. For example, differences in the anatomy of humans based on weight, height, sex, age, etc. can be established. Also, the organs of a first patient can vary from the organs of another patient with respect to size, shape, location, etc. and can have a range of various physiologies, such as a tendency to bleed, firmness, resiliency, sensitivity to certain drugs, possible complications, etc. Allowing groups of trainees to practice virtual reality training within a greater range of real world variations can strengthen the training experience, thereby leading to a better training program for preparing surgeons in training.

Although many examples described in the present disclosure relate to training within the field of virtual surgical, it should be understood that the teachings of the present disclosure may also encompass other fields in which training can be beneficial. Other advantages will become apparent to one of ordinary skill in the art from an understanding of the present disclosure.

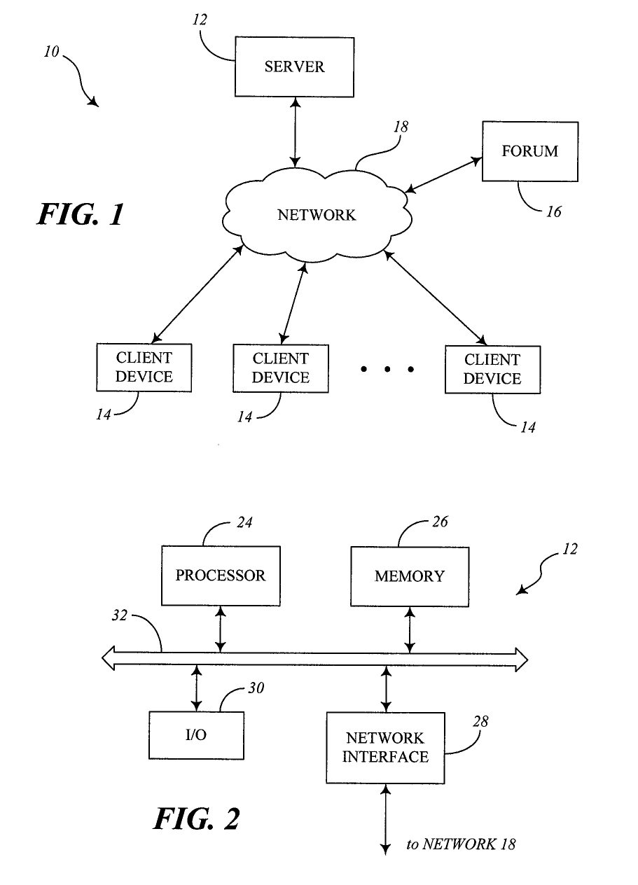

FIG. 1 is a block diagram of an embodiment of a virtual training system 10. Virtual training system 10 in this embodiment includes a server 12, a number of client devices 14, and a forum 16, each in communication with each other via a network 18. Network 18 may include a local area network (LAN), wide area network (WAN) such as the Internet, or other suitable communication system. Network 18 may include any suitable combination of wired or wireless communication channels, nodes, routers, etc. for enabling communication among the various end terminals. Server 12 is configured in this embodiment to receive and transmit information regarding virtual training. The client devices 14 are also capable of receiving and transmitting virtual training information. Forum 16, which can be managed by an administrator, allows clients to post messages concerning different aspects of virtual training. Forum 16 can also encourage users with similar experiences or expertise to share ideas and exchange information.

Client device 14 may include, or may be associated with, a virtual reality device, which can be used for training purposes. The virtual reality device is adapted to store training simulation software from a physical medium or downloaded from server 12. Client device 14 can also receive updates or patches to the simulation software from server 12 when they become available. Client device 14 can also include a database of variations of virtual patients, in the case of use in the medical field, or variations of other subjects within the virtual realm. Also, a number of various virtual tools can be utilized in the training simulation software, depending on the particular procedure being practiced.

Not only is client device 14 able to receive training simulation software, updates, and variations of subjects, but also client device 14 can upload information to server 12. The information sent to server 12 may include actual patient data, such as medical images, test results, anatomical data, physiological data, etc. Uploaded medical data can also include information such as CT scans, x-rays, or other optical imaging data. In addition to this type of information, the client may wish to request that server 12 create and make accessible a customized training scenario.

Also, the information sent from client device 14 to server 12 may include certain sets of standards for performing a particular surgical procedure, results or scores of a current training routine, etc. In addition, the upstream information may include requests to search available downloads and updates, requests to automatically download updates, requests to purchase available downloads, etc. For instance, client device 14 can be configured to automatically access a website associated with server 12 upon an initial boot-up procedure. By initially accessing the server website, client device 14 can discover any new variations or downloads that may be available.

In response to the uploaded information from the different client devices 14, server 12 can respond in many ways. For example, server 12 may receive information concerning new variations or new standards for surgical methods along with a request to create new training scenarios or versions based on the new variations or standards. In response to this information and request, server 12 can begin a process to create customized simulation software or patches. The creation process may include semi-automated processes, but may also include the input of people working at server 12 facility. Server 12 may prompt the server facility workers, such as artists, software programmer, and/or medical professionals, to create the customized simulation information, which includes data, models, information, and/or software and is collectively referred to herein as virtual training software or training simulation software. In this business process, the workers create the custom software and load this new software onto server 12 for downloading to the client devices 14.

Server 12 may include a database and/or accessibility rules dictating which client devices 14 may be able to download new software. For example, downloads may be limited based on confidentiality laws, subscription contracts with the clients, client status, etc. In this respect, a client device 14 may be configured to download certain types of new training simulation software based on the types of surgical procedures that a physician or group of physicians may be interested in or involved with. Also, depending on the configuration of client device 14 with respect to the device's hardware platform, software platform, licensing status, etc., certain downloading protocols and/or limitations may be imposed.

FIG. 2 is a block diagram of an embodiment illustrating the details of server 12 shown in FIG. 1. In this embodiment, server 12 includes a processor 24, memory 26, a network interface 28, and input/output devices 30, each interconnected via a bus 32. Processor 24 executes software residing in memory 26 and manages the overall operations of server 12. Memory 26 includes, among other things, software dedicated to creating enhancements to virtual training software and communicating information related to virtual training to the client devices 14. Particularly, the software for making enhancements and for downloading may be executed automatically or semi-automatically. Network interface 28 is connected to network 18 (FIG. 1) and may include any suitable device for communicating via network 18, such as by using modems, cable modems, wired or wireless communication mechanisms, etc. Network interface 28 is further configured to receive information associated with virtual training from one or more downstream client device 14.

The input/output devices 30 may include any suitable combination of keyboards, keypads, computer mice, drafting mechanisms, digital cameras, etc., allowing staff at the server facility to enter or modify data in memory 26. Data may be entered by artists, programmers, medical personnel, et al., for creating or updating virtual training software, various training scenarios, or virtual patient variations from information uploaded by client devices 14. The server facility staff utilizes the information using programs, such as computer aided design (CAD) programs, stored in memory 26. For any information that can not be entered automatically by server 12, the server facility staff can be instructed how to enter the information. The input/output devices 30 may also include other mechanisms for data entry as needed.

Processor 24 may be a general-purpose or specific-purpose processor or microcontroller. Memory 26 may include internally fixed storage and/or removable storage media for storing information, data, and/or instructions. The storage within the memory components may include any combination of volatile memory, such as random access memory (RAM), dynamic RAM (DRAM), etc., and/or non-volatile memory, such as read only memory (ROM), electrically erasable programmable ROM (EEPROM), flash memory, etc. Memory 26 can also store a software program that enables processor 24 to execute a virtual training programs and procedures.

Various logical instructions or commands may be included in the software program for improving or enhancing virtual training software and managing the distribution of these improvements and enhancements to various users. The virtual training software of the present disclosure can be implemented in hardware, software, firmware, or a combination thereof. When implemented in software or firmware, the software can be stored in memory 26 and executed by processor 24. When implemented in hardware, the virtual training software can be implemented, for example, using discrete logic circuitry, an application specific integrated circuit (ASIC), a programmable gate array (PGA), a field programmable gate array (FPGA), etc., or any combination thereof.

In the embodiment of FIG. 2, memory 26 is illustrated as being part of server 12. In other embodiments, parts or all of the memory components associated with server 12 may be configured in other processing systems or incorporated on a removable storage device. Also, memory 26 may also include remote storage that is accessible by server 12 via a modem or other network communication device.

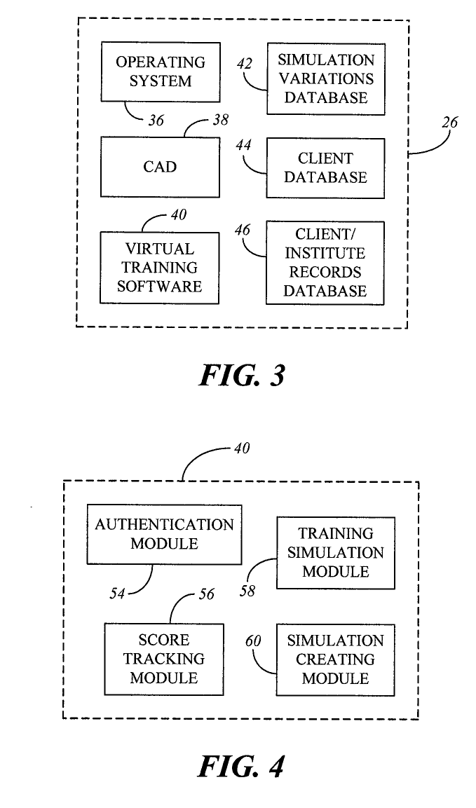

FIG. 3 is a block diagram of an embodiment of memory 26 shown in FIG. 2. Memory 26 in this embodiment includes an operating system 36, a CAD program 38, virtual training software 40, simulation variations database 42, client database 44, and client/institute records database 46. Memory 26 may include volatile and/or non-volatile storage components for storing data and instructions.

As mentioned above, CAD program 38 may be operated by a team of artists, programmers, and medical professionals working at the server facility. The team may extract relevant information of the anatomy of uploaded patient data and label the various organs. Typically, related software can be used to apply properties based on the type of organ identified. Depending on the complexity of the anatomical data entry and identification, it is anticipated that competent staff members might be able to complete an accurate representation of a virtual patient from the uploaded patient information within a timeframe ranging from about one day to about two weeks. The representation of the virtual patient includes at least the clinically relevant organs and structures, depending on the particular type of simulation being developed. The new or updated training software can be stored as virtual training software 40, which may include earlier versions of the software. In addition, the updates can be downloaded to one or more client devices 14 as needed.

Essentially, virtual training software 40 is associated with simulation variations database 42, client database 44, and client/institute records database 46. Virtual training software 40 can access information in these databases 42, 44, 46, as needed, and also store new information in the databases as needed. Virtual training software 40 includes basic simulation functional instructions that can be downloaded to the clients. By accessing data from a number of different types of surgical procedures, which may be stored in virtual training software 40 or in simulation variations database 42, virtual training software 40 creates a virtual surgical procedure. Depending on the subscription or licensing definition of the clients, certain surgical procedures will be made available to authorized clients. Virtual training software 40 also accesses one of a number of variations or ranges of variability of virtual patient information from simulation variations database 42.

The ranges of variation can be updated in simulation variations database 42 based on uploaded patient information. In some cases, simulation variations database 42 includes specific data for a particular patient case that may be confidentially stored for one particular client. Simulation variations database 42 may include different surgical procedures, such as a virtual appendectomy or virtual laparoscopic cholecystectomy.

Client database 44 stores information about each client and records which portions of the training information each client is authorized to access via the different client devices 14. For example, client database 44 may store a list of clients that may be authorized to access the website of server 12. The virtual training system 10 may be structured such that a client is required to maintain a subscription to the virtual training system 10. Unless a client is properly registered in the virtual training system 10, client device 14 cannot access the website of server 12. Client database 44 may also store information regarding certain tiers or levels of subscription, indicating the extent to which the client can access simulation information. Different client plans can be established and stored in client database 44 as well. These different plans may depend on the types of surgical procedures that a client may subscribe to. Other authorization information regarding different clients can be stored in client database 44. Virtual training software 40 utilizes client database 44 to determine how the clients are managed with respect to available training software information, updates, variations, etc.

Client/institute records database 46 stores information regarding training results using virtual training software 40. Depending on certain scoring or grading criteria, the client using the training software can receive a score during the training. The database 46 stores records of the scores for each client or group of clients. In some embodiments, client/institute records database 46 may store the results for an entire hospital, institute, or group of doctors. These records can be kept for the purpose of monitoring certain training methods or individual success. Depending on confidentiality issues, the scores can be accessed to determine training results for individuals or groups of trainees.

FIG. 4 is a block diagram of an embodiment of virtual training software 40 shown in FIG. 3. Particularly, virtual training software 40 in this embodiment includes an authentication module 54, a score tracking module 56, a training simulation module 58, and a simulation creating module 60. Authentication module 54 utilizes the data in client database 44 (FIG. 3) to determine the status of different clients. This information is used to determine whether or not a client is authorized to access or download certain files from the virtual training system 10. Score tracking module 56 uses a scoring system to monitor the performance of users of virtual training software 40. Certain criteria may be used to evaluate the users, such as criteria related to the ability to minimize bleeding, time to complete procedure, or other efficiency or effectiveness measures. The evaluations can be customized by the clients depending on specific methods for performing a surgical procedure. Otherwise, server 12 sets the evaluation standards for measuring success of the virtual training.

Training simulation module 58 essentially includes the simulation software for creating a virtual training environment. This software may be used to define how tools are manipulated in the virtual environment, how a virtual patient reacts to certain procedures, etc. Training simulation module 58 may simply contain the original training software or may also include different surgical procedures, updates, patches, or other variations to the original software.

Also, training simulation module 58 may define how the virtual training is used by the client. For example, the client may use the software in a teaching setting where the surgical procedure is demonstrated to medical students. In other embodiments, training simulation module 58 may define the software in a way to allow the clients to interact using virtual reality equipment. Training simulation module 58 may further define other uses for virtual training software 40, such as in a presentation to a group of medical professionals. Simulation creating module 60 may be used to assist in creating new, updated, or customized variations of virtual training software 40. For instance, simulation creating module 60 can be used with CAD program 38 (FIG. 3) to create virtual images from a CAD drawing. In this respect, simulation creating module 60 can store definitions and properties of various internal organs such that identification of an organ can be used to relate the specific properties of the organ. Based on new information uploaded from the clients, simulation software can be added or modified.

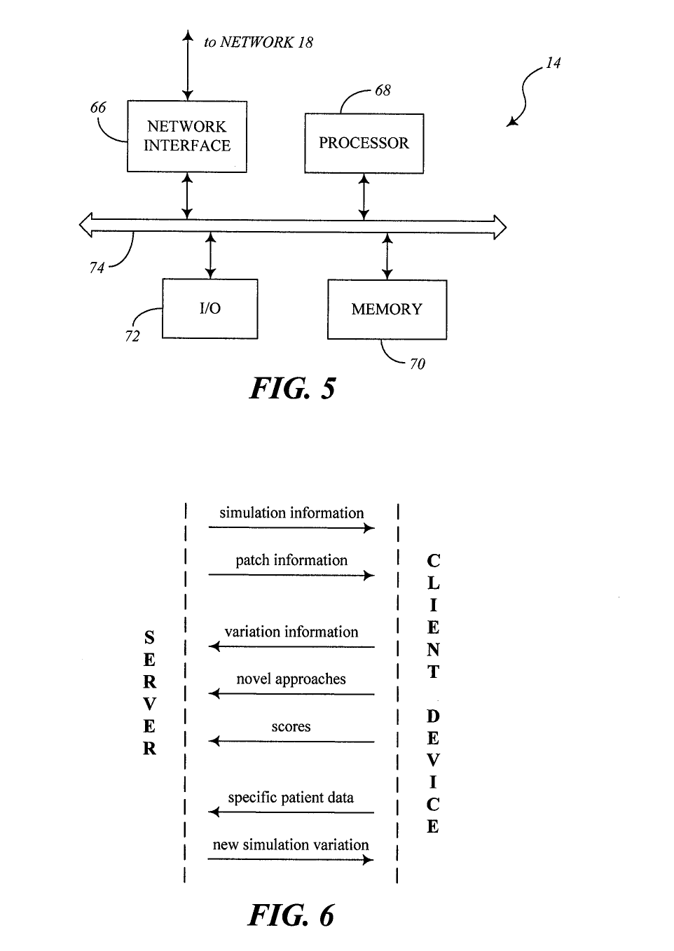

FIG. 5 is a block diagram of an embodiment of client device 14 shown in FIG. 1. According to this embodiment, client device 14 includes a network interface 66, a processor 68, memory 70, and input/output (I/O) devices 72, each interconnected via bus 74. Network interface 66 may include any suitable communication device, such as a modem, for communicating with server 12 (FIG. 1) via network 18. Network interface 66 is configured to transmit information to server 12 and receive information from server 12. Specifically, the information refers to training simulation information as mentioned above.

Input/output (I/O) devices 72 include input mechanisms such as keyboards, keypads, cursor control devices, e.g. computer mice, or other data entry devices. Output devices may include a computer monitor, virtual reality display device, audio output device, printer, or other peripheral devices. I/O devices 72 can communicate with bus 74 via wired or wireless transmission. The user or client can enter the type of simulation procedure to be performed using I/O devices 72. Also, the client may enter medical images, messages regarding how a novel approach to a surgical procedure can be performed, variations in patient anatomy and physiology, etc.

Memory 70 stores a version of the software related to virtual training software 40 (FIG. 3). In this respect, the software may be referred to as a virtual reality program that receives user input and displays virtual reality images on a display device of I/O devices 72. Memory 70 may include a boot program designed to access server 12 when client device 14 first boots up. In this respect, client device 14 can automatically access the website of server 12 to automatically download updates, if properly authorized to do so. In other embodiments, the client may be shown available software updates and prompts allowing the client to download the updates. If not authorized to download without payment, the client may purchase downloads or updates to the training software if desired.

The virtual reality program stored in memory 70 may include any updates regarding virtual patient variations. Also, the program includes a scoring system to record a score during the virtual training session. Scores stored in memory can be automatically uploaded to server 12 via network interface 66 according to preset criteria. The virtual reality program also includes various simulations for different surgical procedures and can update the simulations with downloaded patches.

Virtual training software 40, the virtual reality program stored in memory 70, and any other programs or software code including executable logical instructions as described herein can be embodied in any suitable computer-readable medium for execution by any suitable processing device. The computer-readable medium can include any physical medium that can store the programs or software code for a measurable length of time.

FIG. 6 is a graph illustrating an embodiment of possible information exchange between server 12 and a client device 14. Traditionally, a server would merely download simulation information and any patch information to the client device as needed, according to the top two directional arrows. The simulation information in this case represents surgical procedure data, virtual tools, virtual patients and variations, etc. The patch information represents, for example, updates to the virtual training software and enhancements to the software.

According to the virtual training system 10 described herein, additional information exchange is now possible. For example, the client device can transmit information regarding variations that may have been experienced in the field. These variations may include actual patient data, such as from CT scans, etc., or variations with respect to the physiology of a patient. Other information sent from the client device to the server may include novel approaches to performing certain surgical procedures. For example, based on various techniques for performing a certain type of surgical procedure, new methods may be attempted to explore possibly improved medical procedures. Also, the client device can send scores or evaluation information to the server based on the execution of the virtual training. The scores can be sent automatically by the client device or in response to an action by the client.

In some embodiments, when the virtual training system 10 is used in a medical environment, client device 14 can send specific data related to an actual patient. In other fields, specific data of other types of virtual subjects can be transmitted. The patient data may be obtained from a real patient who may not fall into a category that can be represented accurately by the typical range of virtual patients. In this case, a customized simulation variation may be requested. The patient data may include CT scans or other image information. In other embodiments, the information may include a verbal or textual description of the location of organs or the anatomy of the patient. Also, information regarding the physiology or characteristics of the organs of a specific patient may be transmitted upstream. In response to the specific patient data and the request to server 12 to create a customized training scenario, server 12 can create and then download the new simulation variations to the client.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein merely represent examples of implementations and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A server comprising:
memory configured to store virtual training software and a simulation variations database, the virtual training software comprising training simulation logic adapted to provide a virtual training experience, the simulation variations database comprising data associated with preset variations to the virtual training experience; and
a network interface configured to communicate with a remote client device within a network;
wherein the network interface is further configured to receive, from the client device, a first set of information configured to modify at least one of the virtual training software and the simulation variations database; and
wherein the network interface is further configured to transmit, to the client device, a second set of information associated with a modification of at least one of the virtual training software and simulation variations database.

2. The server of claim 1, wherein the virtual training software comprises an authentication module adapted to limit access to the virtual training software only to authorized clients on one or more client devices.

3. The server of claim 2, further comprising a client database stored in memory, the client database including a list of the authorized clients.

4. The server of claim 1, wherein the virtual training software further comprises logic adapted to create additional simulation variations.

5. The server of claim 4, wherein the logic adapted to create additional simulation variations creates variations in response to the first set of information.

6. The server of claim 4, wherein the network interface is further configured to automatically download the additional simulation variations to the client device.

7. The server of claim 1, wherein the simulation variations comprise variations of a virtual subject receiving actions of a virtual tool.

8. The server of claim 7, wherein:
the virtual training software comprises logic adapted to provide a virtual surgery experience;
the virtual subject is a virtual patient; and
the virtual tool is a virtual surgical tool.

9. The server of claim 1, wherein the network interface is configured to communicate with a plurality of client devices within the network.

10. The server of claim 1, wherein the network interface is further configured to download patch information associated with the virtual training software.

11. The server of claim 1, wherein the virtual training software comprises logic adapted to track scores related to performance characteristics of a client using the client device to experience the virtual training.

12. The server of claim 11, wherein the memory further comprises a records database for storing the scores.

13. Virtual training software embodied on a computer-readable medium and executable by a processor, the virtual training software comprising:
a training simulation module comprising training logic to perform a virtual reality training exercise, wherein portions of the training logic can be downloaded to a plurality of remote client devices;
authentication logic adapted to determine whether a specific client device of the plurality of remote client devices is authorized to access the training simulation module; and
simulation creating module comprising logic to create additional simulation variations in response to input from the specific remote client device when it is determined that the specific client device is authorized to access the training simulation module.

14. The virtual training software of claim 13, wherein the simulation creating module further comprises logic to store the created simulation variations in a database.

15. The virtual training software of claim 13, wherein the authentication module is configured to access of a list of authorized client devices from a database.

16. The virtual training software of claim 13, further comprising a score tracking module having logic to receive scores from client devices, wherein the scores are related to performance success of users of the training logic.

17. A client device in communication with a virtual training network, the client device comprising:
a network interface configured to communicate with a training simulation server within the virtual training network;
memory configured to store a virtual reality training program adapted to receive input control signals from a user and to display virtual reality images;
wherein the network interface is further configured to transmit, to the training simulation server, information related to a modification of the virtual reality training program.

18. The client device of claim 17, wherein the transmitted information comprises variations of real world scenarios associated with the virtual reality training program.

19. The client device of claim 17, wherein the transmitted information comprises a different approach for performing medical procedures associated with the virtual reality training program.

20. The client device of claim 17, wherein the transmitted information comprises a score based on performance of a user executing the virtual reality training program.

21. A method comprising:
receiving information associated with virtual reality training software from a client device;
modifying the virtual reality training software based on the information received from the client device; and
transmitting at least a portion of the modified virtual reality training software to the client device.

22. The method of claim 21, further comprising:
transmitting at least the portion of the modified virtual reality training software to a plurality of client devices.

23. The method of claim 21, wherein modifying the virtual reality training software further comprises:
forwarding the received information to one or more human operators;
enabling the one or more human operators to execute software adapted to identify organs of a real world surgical patient;
creating a model of a virtual patient from the identified organs; and
adding the created model to a database including variations of virtual patients associated with the virtual reality training software.
